(19) United States
(12) Patent Application Publication
(10) Pub. No.: US 2023/0048030 A1
(43) Pub. Date: Feb. 16, 2023

(54) CODING APPARATUSES AND METHODS FOR A JUMPER CABLE FOR A CELLULAR COMMUNICATIONS SYSTEM

(71) Applicant: CommScope Technologies LLC, Hickory, NC (US)

(72) Inventors: Amit KAISTHA, Coppell, TX (US); Paul EVEREST, Flower Mound, TX (US); Joy HUANG, Plano, TX (US); Khanh Duy TRAN, Rowlett, TX (US); Steven ROGERS, Garland, TX (US); Michel DEMBINSKI, Dallas, TX (US); Samantha L. MERTA, Richardson, TX (US)

(21) Appl. No.: 17/794,373

(22) PCT Filed: Jan. 12, 2021
(86) PCT No.: PCT/US2021/013053

§ 371 Date: Jul. 21, 2022

Related U.S. Application Data
(60) Provisional application No. 62/966,181, filed on Jan. 27, 2020.

(51) Int. Cl. G09F 3/18; G09F 3/02

(52) U.S. Cl. CPC G09F 3/18; G09F 3/02; G09F 2003/0266; G09F 2003/0208

(57) ABSTRACT

A coding apparatus is mounted on a jumper cable. The coding apparatus includes a plurality of coding symbols. A selection mechanism is part of the coding apparatus and is operable to reveal a selected plurality of coding symbols of the plurality of coding symbols. The selected plurality of coding symbols, in combination, provide a code identifying a connection location for the jumper cable.

### BACKGROUND

The present invention generally relates to radio communications systems and, more particularly, to base station antennas and remote radio units for cellular communications systems.

Cellular communications systems are well known in the art. In a cellular communications system, a geographic area is divided into a series of regions that are referred to as “cells,” and each cell is served by a base station. The base station may include one or more base station antennas that are configured to provide two-way radio Frequency Band (“RF”) communications with mobile subscribers that are geographically positioned within the cells served by the base station. Typically, the antennas are mounted on a tower or other raised structure, with the radiation beam(s) that are generated by each antenna directed outwardly to serve the respective coverage area.

In order to increase capacity, some cellular base stations now employ beam-forming radios and multi-column beam-forming antennas. In some beam-forming antennas, each column of radiating elements is coupled from a RF port on the antenna to a respective RF port of a remote radio unit. The remote radio unit may adjust the amplitude and phase of the sub-components of an RF signal that are passed to each RF port so that the columns of radiating elements work together to form a more focused, higher gain antenna beam that has a narrowed beamwidth in the azimuth and/or elevation planes.

As the number of columns of radiating elements increases, the number of RF ports that must be connected between the remote radio unit and the antenna increases. For example, a four column beam forming array is typically fed by two RF ports per column as well as a calibration port for a total of nine ports. In other embodiments, the antenna may have 24 RF ports as well as two calibration ports for a total of 26 ports. The number of ports on an antenna and corresponding remote radio unit are increasing such that antennas and remote radio units having 48 ports or an even greater number of ports are known. As the number of ports increases the complexity of connecting the ports on the antenna to the corresponding ports on the remote radio unit increases. Each RF port on the antenna must be connected to the appropriate RF port on the remote radio unit by a jumper cable. If the RF ports on the remote radio unit are misconnected to the RF ports on the antenna, the system performance will be degraded. Moreover, it may be difficult to detect the cause of the system performance degradation, and correcting the problem typically requires an expensive tower climb.

The connections of the RF ports on the remote radio unit to the RF ports on the antenna are typically made by a technician operating at the top of the tower or other structure. The large number of connections that need to be made, the difficult installation conditions, and the increasing complexity of the equipment on the tower can result in the misconnection of the jumper cable to the ports on the remote radio unit and the ports of the antenna.

In order to facilitate the installation of the antennas and remote radio units, it is known for technicians to use a color coding system to ensure that the jumper cable is connected to the correct corresponding ports on the antenna and the remote radio units. As currently devised, the technician, using a plumbing diagram, marks both ends of the jumper cable with colored tape, such as colored electrical tape. In some systems, each end of the jumper cable may be marked with up to four different color tapes selecting from up to nine different colors. The process of marking the jumper cables in this manner is time consuming and expensive.

### BRIEF DESCRIPTION OF THE DRAWINGS

FIGS. 1A-1C are a side view, a back view, and an end view, respectively, of an exemplary base station antenna according to embodiments of the present invention.

FIG. 1D is a schematic diagram illustrating the jumper cable connections between an antenna and a remote radio unit.

FIG. 2 is a perspective view of an embodiment of a pair of coding apparatuses mounted on a jumper cable.

FIG. 3 is a detailed view of FIG. 2 showing the coding apparatuses in greater detail.

FIG. 4 is a perspective view of the apparatus of FIG. 2 showing the coding apparatuses at the respective ends of the jumper cable.

FIGS. 5, 6 and 7 are perspective views of one of the coding apparatuses of FIG. 2.

FIG. 8 is a side view of one of the coding apparatuses of FIG. 2 with the covers removed.

FIG. 9 is a perspective view of another embodiment of a pair of coding apparatuses mounted on a jumper cable.

FIG. 10 is a detailed view of FIG. 9 showing the coding apparatuses in greater detail.

FIG. 11 is a perspective view of the apparatus of FIG. 9 showing the coding apparatuses at the respective ends of the jumper cable.

FIGS. 12, 13 and 14 are perspective views of one of the coding apparatuses of FIG. 9.

FIG. 15 is a perspective view of the apparatus of FIG. 9 showing the coding bands.

FIG. 16 is a side view of one of the coding apparatuses of FIG. 9.

FIG. 16A is a section view taken along line 16A-16A of FIG. 16.

FIG. 17 is a perspective view of another embodiment of a coding apparatus.

FIG. 17A is a perspective view of another embodiment of a coding apparatus

FIG. 18 is a perspective view showing jumper cables and coding apparatuses of FIG. 2 mounted on an antenna.

FIG. 19 is a perspective view showing jumper cables and coding apparatuses of FIG. 9 mounted on an antenna.

FIG. 20 is a diagram illustrating an embodiment of a coding scheme.

### DETAILED DESCRIPTION

Pursuant to embodiments of the present invention, coding systems and apparatuses for connecting jumper cables to the ports of antennas and remote radio units in cellular communications systems are provided. The coding apparatuses and systems are easier to use and more cost effective than existing systems, eliminate loose components, and reduce installation time.

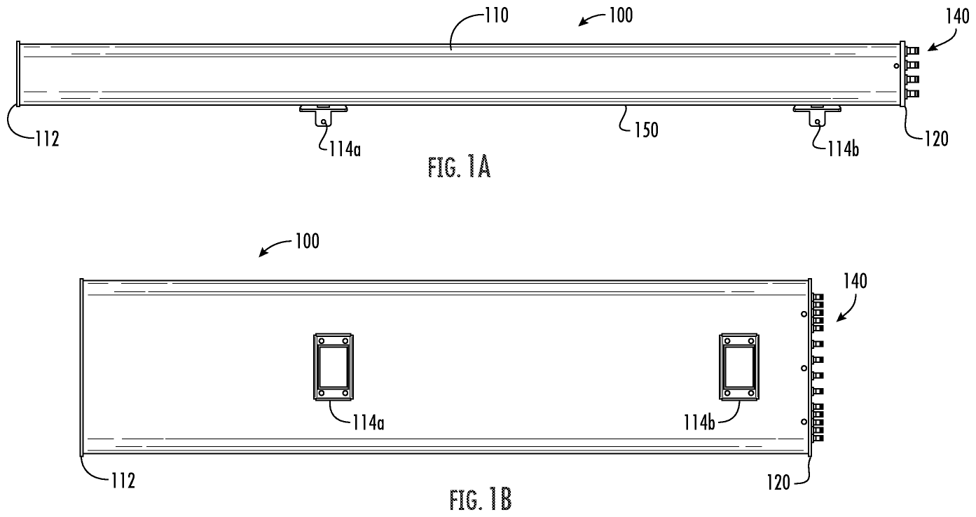

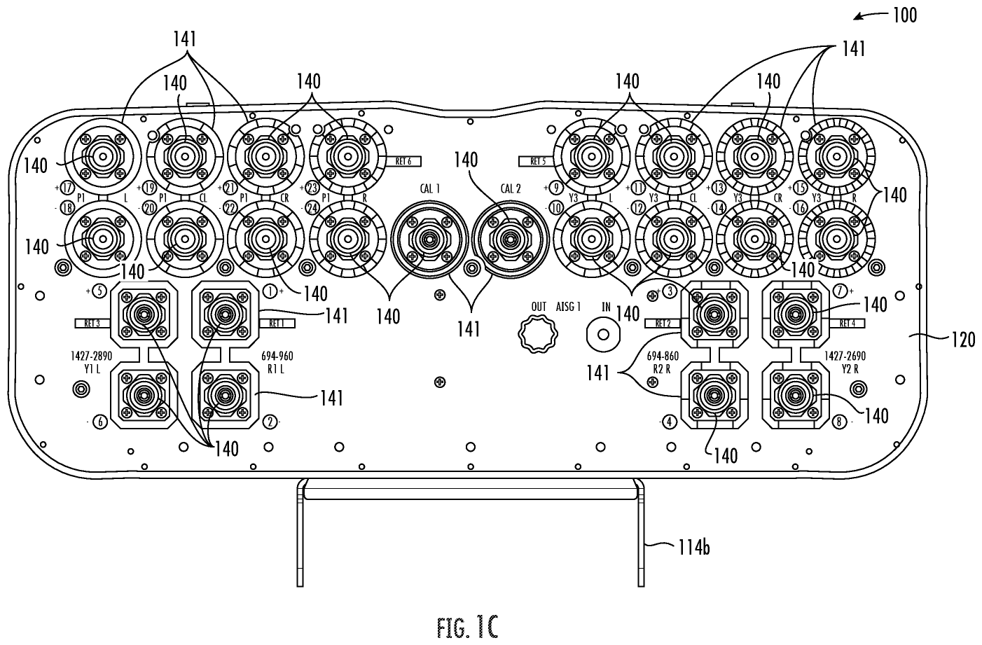

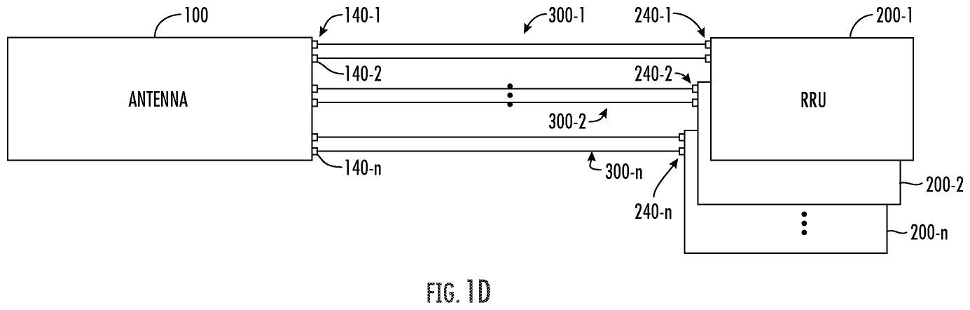

Embodiments of the present invention will now be described in further detail with reference to the attached figures. FIGS. 1A-1C illustrate one embodiment of a base station antenna 100 that may utilize the coding systems and apparatuses according to certain embodiments of the present invention. While a particular embodiment of an antenna is described in detail herein, the coding systems and apparatuses described herein may be used with virtually any type of antenna and remote radio unit and the coding systems and apparatuses are not limited to use with the antenna and/or remote radio unit structures as specifically shown and described herein.

As shown in FIGS. 1A-1C, the antenna 100 may be an elongated structure and may have a generally rectangular shape. In an example embodiment, the width and depth of the antenna 100 may be fixed, while the length of the antenna 100 may be variable. The antenna 100 includes a radome 110 and a top end cap 112. The antenna 100 also includes a bottom end cap 120 which includes a plurality of ports or connectors 140 mounted therein. The antenna 100 is typically mounted in a generally vertical configuration (i.e., the long side of the antenna 100 extends along a vertical axis with respect to the earth). A pair of mounting brackets 114a, 114b are provided on the rear side of the radome 110 which may be used to mount the antenna 100 onto an antenna mount on, for example, an antenna tower.

The antenna 100 includes an antenna assembly that is positioned behind the radome 110 and may be mounted on a ground plane structure that may include RF choke sections and a reflector surface. Various mechanical and electronic components of the antenna may be mounted to the ground plane structure. These electronic and mechanical components include, among other things, phase shifters, remote electronic tilt (“RET”) units, mechanical linkages, diplexers, and the like.

The antenna assembly includes a plurality of radiating elements (not shown) that are mounted on the reflector surface of the ground plane structure 150. The radiating elements may include radiating elements that transmit and receive signals in different Frequency Bands. The radiating elements may form a plurality of arrays and may be divided into groups. In the illustrated embodiment, the antenna may include two single column arrays of cross-polarized radiating elements (herein “X-pol arrays”) for transmitting and receiving signals at 694-960 MHz; two single column X-pol arrays for transmitting and receiving signals at 1427-2690 MHz; a 1×4 column array for transmitting and receiving signals at 2300-2690 MHz and a separate 1×4 column array for transmitting and receiving signals at 3300-3800 MHz where a calibration port is provided for each 4-column array.

Referring to FIG. 1C, in such an antenna configuration, twenty-six ports 140 may be provided on the bottom end cap 120. The RF ports 140 in FIG. 1C are identified by port numbers 1-24 with the two calibration ports being identified as CAL 1 and CAL 2. The RF ports 1-24 are also arranged in groups according to the operating frequency band of the ports. Port Nos. 1 and 2 and Port Nos. 3 and 4 operate at 694-960 MHz; Port Nos. 5 and 6 and Port Nos. 7 and 8 operate at 1427-2690 MHz; Port Nos. 9-16 operate at 2300-2690 MHz and Port Nos. 17-24 operate at 3300-3800 MHz. The ports 140 are also identified by Antenna Interface Standards Group (ASIG) standardized indicia 141. Each port 140 is encircled by indicia 141 that are distinguished by shape, pattern and color (not shown) for the different frequency bands and calibration ports.

Antennas having six, eight or twelve RF ports are common, while newer antennas may require far more RF connections such as the 24 RF ports of FIGS. 1A-1C. As described above, a base station antenna may include two linear arrays of low-band radiating elements, two linear arrays of first mid-band radiating elements, a four column planar array of second mid-band radiating elements and a four column planar array of high-band radiating elements. All of the radiating elements may comprise dual-polarized radiating elements. Consequently, each column of radiating elements will be fed by two separate connector ports on a radio, and thus a total of twenty-four RF connector ports are required on the base station antenna to pass RF signals between the twelve separate columns of radiating elements and their associated RF ports on the remote radio units. Moreover, each of the four column planar arrays of radiating elements are operated as a beamforming array, and hence a calibration connector port is required for each such array, raising the total number of RF ports required on the antenna to twenty-six. Other ports such as control ports may also typically be required which are used, for example, to control electronic tilt circuits included in the antenna.

Referring to FIG. 1D, each port 140-1 to 140-n on the antenna 100 is connected to a corresponding port 240-1 to 240-n on remote radio units (RRUs) 200-1 to 200-n by jumper cables 300-1 to 300-n. Typically, the remote radio units (RRUs) 200 comprise ports 240 that correspond in a one-to-one manner to the ports 140 on the antenna 100. In one typical arrangement for the antenna described above there may be two low-band RRUs, three mid-band RRUs and one high-band RRUs although the number and type of RRUs can vary from the arrangement described herein. The RRUs 200 typically do not include the port identifying indicia 141 that is found on the antenna 100.

As cellular operators upgrade their networks to support fifth generation (“5G”) service, the base station antennas that are being deployed are becoming increasingly complex. For example, due to space constraints and/or allowable antenna counts on antenna towers of existing base stations, it may not be possible to simply add new antennas to support 5G service. Accordingly, cellular operators are opting to deploy antennas that support multiple generations of cellular service by including arrays of radiating elements that operate in a variety of different frequency bands in a single antenna. Thus, for example, it is common now for cellular operators to deploy a single base station antenna that supports service in three, four or even five different Frequency bands. Moreover, in order to support 5G service, these antennas may include multi-column arrays of radiating elements that support active beamforming. Cellular operators are seeking to support all of these services in base station antennas that are comparable in size to base station antennas that supported far fewer frequency bands. This raises a number of challenges.

One challenge in implementing the above-described base station antennas is that the number of RF ports included on the antenna is large and increasing. In order for the antenna to operate properly it is necessary that each jumper cable 300 connect one port 140 on the antenna 100 to the correct corresponding port 240 on each of the RRUs 200. One challenge in installing and maintaining base station antennas such as described above, is that as the number of RF ports on the antenna and RRUs increases, the opportunity for the technician to connect a RF port on the antenna to the wrong RF port on the RRU increases. If this occurs then degraded service or even loss of the RF connection may occur. Such issues require expensive and time-consuming tower climbs to correct the situation. This problem may be exacerbated by the fact that the denser the array of RF ports the less room there is on the bottom end cap for labels that assist the technician in the installation process.

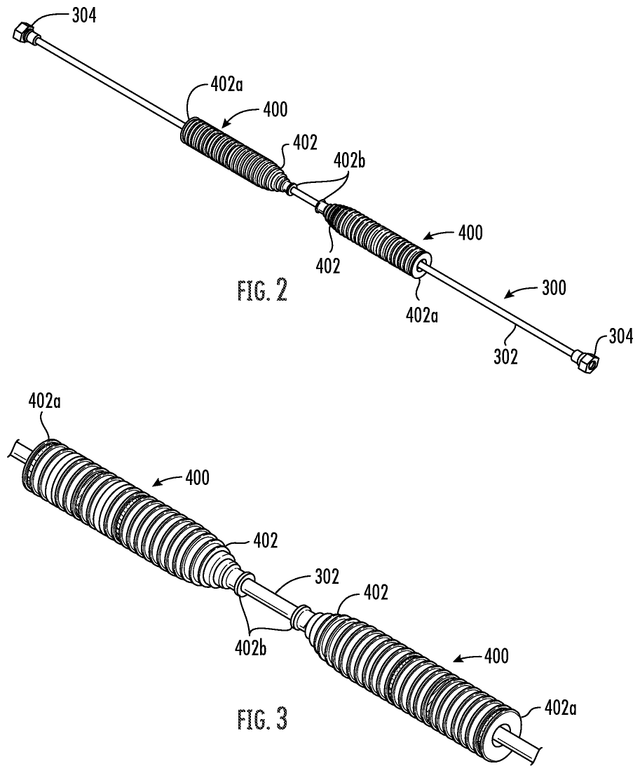

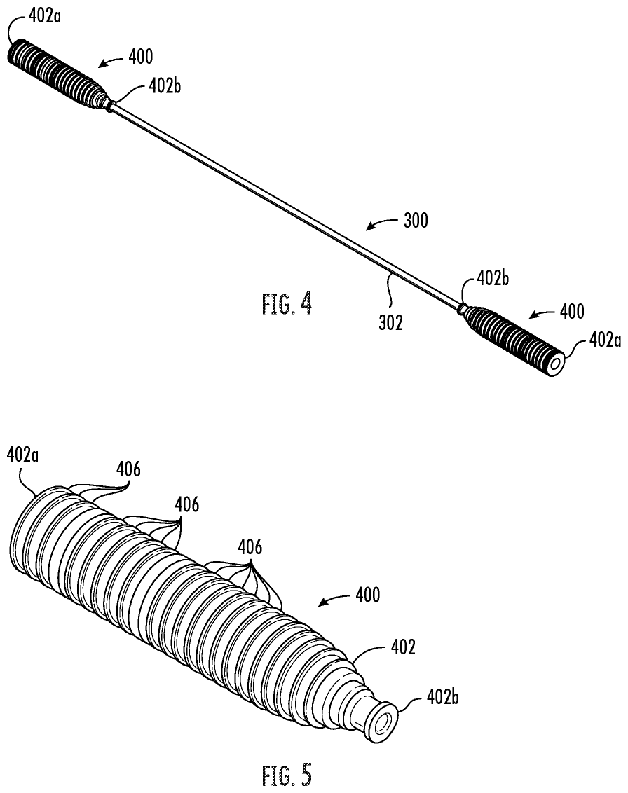

Referring to FIGS. 2-8, one embodiment of a coding apparatus for a jumper cable 300 is shown. The jumper cable 300 may comprise a cable 302, such as a coaxial cable, having a connector 304, such as a screw-on or push-on connector, at each end thereof. A coding apparatus 400 according to embodiments of the invention is provided at each end of the jumper cable 300 such that a coding apparatus 400 is available to the technician at the antenna 100 and at the RRU 200.

The coding apparatus 400 comprises a body 402 having a plurality of coding symbols 404 formed thereon. In one embodiment, the coding symbols 404 comprise coding bands that extend about the entire periphery of the body 402 such that the coding symbols 404 are visible from any angle. Each of the coding symbols 404 comprises a visual and/or tactile indicator that may be viewed or otherwise sensed (such as by touch) by the technician. A selection mechanism is used to selectively reveal selected ones of the coding symbols where the combination of the selected ones of the coding symbols identifies the port to which the jumper cables is to be connected. In the present embodiment, the selection mechanism is a separate removable cover 406 covering each of the coding symbols 404 such that the covers may be removed to reveal the selected ones of the coding symbols. In a typical application two, three or four of the coding symbols 404 may be revealed to identify a port as will be hereinafter explained, although any number of coding symbols 404 may be used to identify a port. The coding symbols 404 that do not form part of the code for the port the jumper cable is to be connected remain covered by covers 406 such that less than all of the coding symbols 404 are revealed to create, in combination, the code that is used by the technician to identify the connection location (port 140/240) of the jumper cable.

In the embodiment of FIGS. 2-8, the coding apparatus 400 comprises a body 402 that is formed as a guard boot. As is known, a guard boot is a device that is movably mounted on a cable 302 and that forms a sheath that may cover the connection between the cable connector 304 and the port 140, 240 to protect the connection and prevent water, or other liquids from contacting and penetrating the electrical connection. The body 402 comprises an outer end 402a that forms the guard boot and is dimensioned to closely cover the connector 304 and port 140, 240 as shown in FIG. 4. The body 402 also comprises a narrow inner end 402b that closely but slidably receives the cable 302. The body 402 includes an internal passage that receives the cable such that the coding apparatus 400 may be slid along the cable 302 to cover the port 140, 240 and connector 304 after the connection between these components is made.

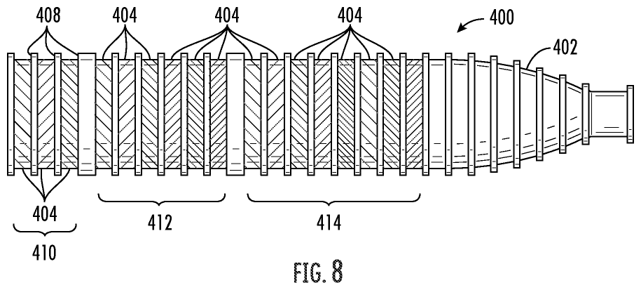

The body 402 may be formed with a plurality of grooves 408 that receive the coding symbols 404. In some embodiments, the RE ports 140 and 240 on the antenna 100 and RRU 200, respectively, may be identified using three identifier variables (Sector, Frequency Band and Port number) with the calibration ports being identified using a fourth identifier, as will hereinafter be described. The coding symbols 404 may be divided into a corresponding number of sections 410, 412 and 414 (FIG. 8) where each section includes a group of coding symbols 404 that identify one of the three identifier variables. In the illustrated embodiment, the first section 410 identifies the Sector variable, the second section 412 identifies the Frequency Band variable and the third section 414 identifies the Port Number. The illustrated coding apparatus 400 is designed for use with an antenna 100 and RRU 200 such as shown in FIG. 1C. In the illustrated coding apparatus 400, the first section 410 includes a first group of three coding symbols 404, the second section 412 includes a second group of six coding symbols 404 and the third section 414 includes a third group of eight coding symbols 404. A greater or fewer number of coding symbols may be used depending on the number of sectors, frequency bands and ports provided that the coding symbols may be used in combinations that uniquely identify each of the ports 140/240.

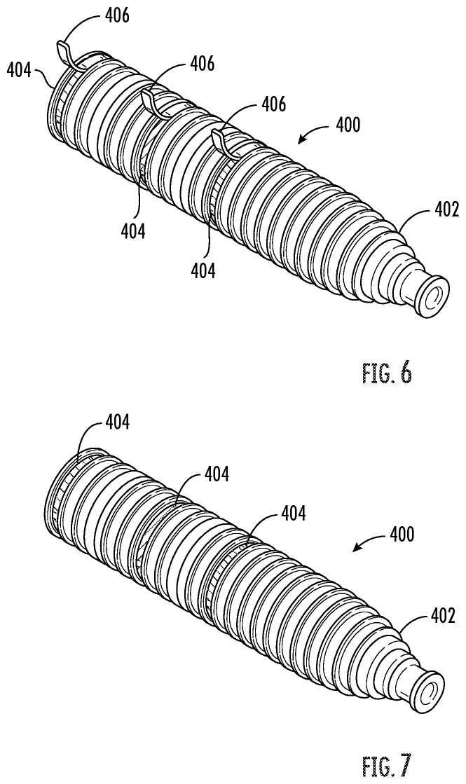

In one embodiment, the body 402, the bands that form the coding symbols 404 and the removable covers 406 are made of a relatively soft, flexible material such as silicone. In one embodiment, the coding apparatus 400 may be molded in an insert molding operation. In such an operation, the bands that form the coding symbols 404 may be pre-formed and stacked in an injection mold. The material of the body 402 and covers 406 may then be injected into the mold. to form the body 102 under the coding rings 404 and the covers 106 over the coding rings 404 to create the coding apparatus as shown in FIG. 5. The intersection between the covers 406 and the body 402 may be formed with reduced thickness to facilitate the tearing of the covers 106 from the body 102 to reveal the underlying coding symbols 401, see FIGS. 6 and 7. Because the coding apparatus 400 is made of soft, flexible material, the coding apparatus 400 may be deformed and slipped over the connectors 304 and onto the cable 302. In other embodiments, the coding apparatus 400 may be slipped onto the cable 302 before the connectors 304 are attached to the cable 302.

In order to allow the installer to identify the coding symbols 404 with the covers 406 in place, a symbol identifier is used. In one embodiment, the symbol identifier may comprise a letter, word, a color or other indicia formed on the cover 406 that corresponds to the coding symbol 404 covered by that cover 406. For example, a cover 406 that covers a RED coding symbol may include an “R” or the word “RED” or a small area of the color red on the outside of the cover. In other embodiments, the cover 406 may not completely cover the coding symbol 404 such that a small portion of the coding symbol 404 remains uncovered and is visible even when the covers 406 are attached to the body 402. For example, in the cylindrical arrangement shown in FIGS. 5-7, the covers 406 may extend for less than 360 degrees of the band that forms the coding symbols 404. In other embodiments, each cover 406 may include a hole or aperture though which a relatively small portion of the covered coding symbol 404 is visible.

The coding symbols 404 may include any visual and/or tactile indicator or combinations of such indicators. In one preferred embodiment, the indicator is a color band where each port on the RRU and antenna 100 may be identified by a known combination of three or four colored bands as will hereinafter be described. In the illustrated embodiment, the coding symbols 404 are formed of one of eight colors—red, green, blue, yellow, white, brown, purple, and orange. Other colors may be used in addition to those specifically set forth herein and a greater or fewer number of colors may be used. The body 402 may be formed of a contrasting color such as black to enhance visibility of the colored coding symbols. Moreover, each coding symbol 404 may use more than one color. While using color as the indicator is shown, other devices may be used as the indicator such as patterns, shapes, raised tactile areas, words, letters or the like or combinations of such devices. Moreover, the coding symbols 404 may correspond to the ASIG indicia 141 that are provided on the antenna 100.

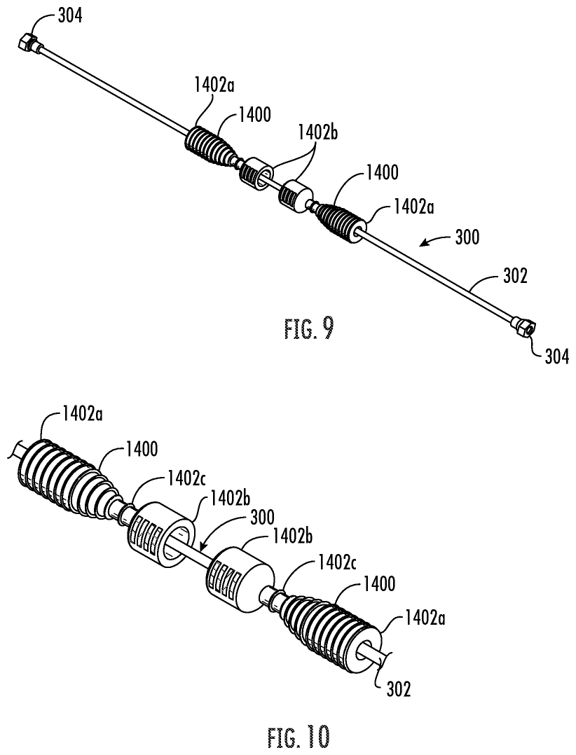

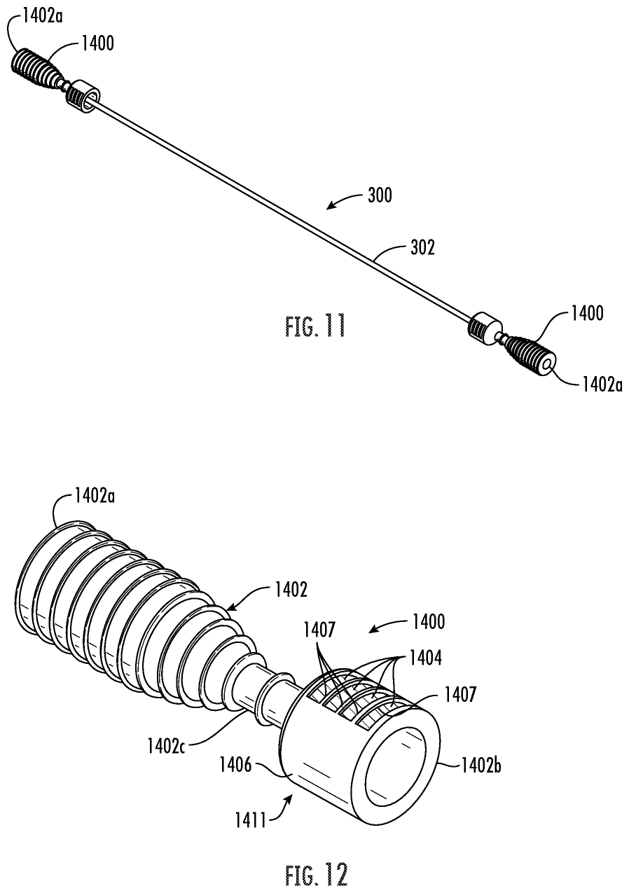

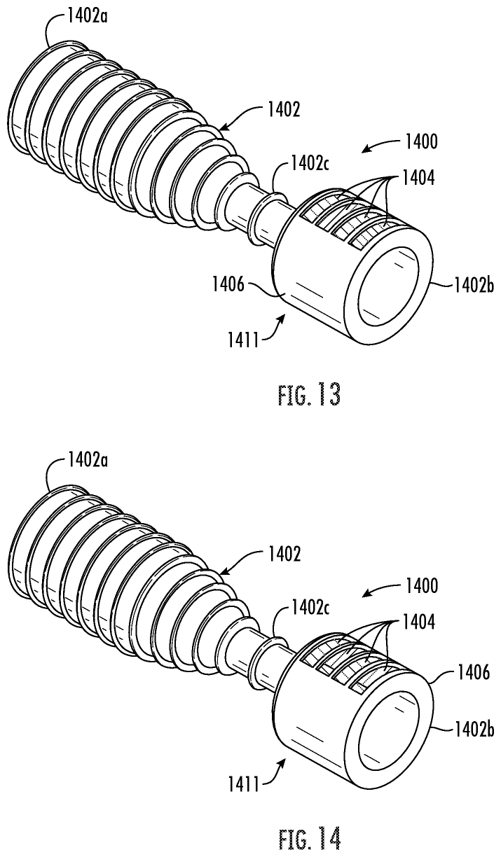

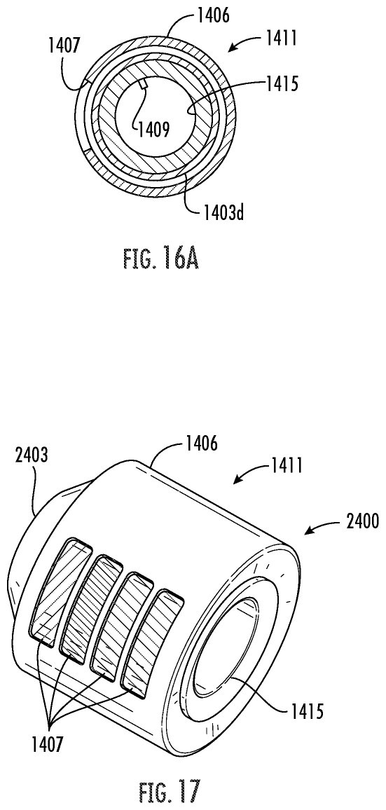

Referring to FIGS. 9-16A, another embodiment of a coding apparatus 1400 for a jumper cable 300 is shown. A coding apparatus 1400 according to embodiments of the invention is provided at each end of the jumper cable 300 such that the code is available to the technician at the antenna 100 and at the remote radio units 200. A selection mechanism is used to selectively reveal selected ones of the coding symbols where the combination of the selected ones of the coding symbols identifies the port to which the jumper cables is to be connected. In the present embodiment, the selection mechanism comprises a plurality of rotatable coding bands that selectively reveal the coding symbols when the coding bands are rotated relative to a cover. The coding apparatus 1400 comprises a body 1402 having a plurality of coding symbols 1404 rotatably mounted thereon such that the coding symbols 1404 are rotatable on and about the body 1402. In one embodiment, the coding symbols 1404 are formed on bands 1403 that extend about the periphery of the body 1402 such that the bands 1403 may be rotated 360 degrees about the body 1402. Each of the bands 1403 comprises at least one and in most cases a plurality of coding symbols 1404 that are spaced about the circumference of the coding rings 1403. A stationary cover 1406 is mounted on the body 1402 and covers the movable coding bands 1403 to retain the bands 1403 on the body 1402. The stationary cover 1406 includes a plurality of apertures or windows 1407 where one of the apertures is aligned with each of the coding bands 1403. The coding bands 1403 may be rotated on the body 1402 such that selected ones of the coding symbols 1404 on each of the coding bands 1404 may be visible through windows 1407. The coding bands 1404 may also include a black portion that is devoid of a coding symbol 1404 and that may be aligned with a window 1407 to black out a selected window that does not form part of the code for the juniper cable.

In the embodiment of FIGS. 9-16, the coding apparatus 1400 comprises a body 1402 that is formed as a guard boot. The body 1402 comprises an outer end 1402a that is dimensioned to closely cover the connector 304 and ports 140, 240. The body 1402 also comprises a narrow center portion 1402c that closely but slidably receives the cable 302. The body 1402 may be slid along the cable to cover the port 140, 240 and connector 304 after the connection between these components is made. The body 1402 also comprises an inner end 1402b that comprises the coding portion 1411. The body 1402 includes an internal passage that receives the cable 302 such that the coding apparatus 1400 may be slid along the cable 302 to cover the port 140, 240 and connector 304 after the connection between these components is made.

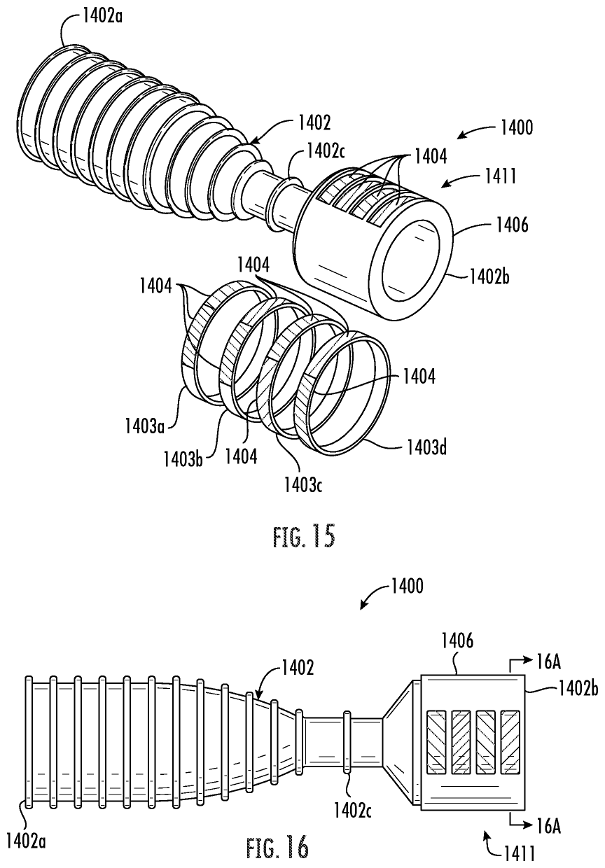

The coding apparatus 1400 includes a coding portion 1411 arranged opposite the guard boot, The body 1402 of the coding portion 1411 is formed as a hollow support cylinder 1415 on which the coding bands 1403 are rotatably mounted. The ports 140 and 240 on the antenna 100 and RRUs 200, respectively, may be identified using three identifier variables (Sector, Frequency Band and Port Number) with the calibration ports being identified using a fourth identifier, as will hereinafter be described. As a result, four coding bands 1403 are rotatably mounted on the body where each coding band 1403 includes at least one and in most cases a plurality of coding symbols 1404. Referring to FIG. 15, in the illustrated coding apparatus 1400, the first band 1403a includes a first group of three code symbols 1404, the second band 1403b includes a second group of six code symbols 1404, and the third band 1403c includes a third group of eight code symbols 1404. A greater or fewer number of coding bands 1403 and code symbols 1404 may be used depending on the number of Sectors, Frequency Bands and Ports provided that the coding symbols 1404 may be used in combinations that uniquely identify each of the ports. The fourth band 1403d includes two code symbols 1404 for identifying the calibration port. Each coding band 1403 is independently rotatable relative to the support cylinder 1415 to reveal a selected one of the code symbols 1404 through the associated window

The code bands 1403 may include protrusions 1409 that extend through the wall of the support cylinder 1415 of the coding portion 1411 that may be accessed by a finger of the installer through the hollow support cylinder 1415 to independently rotate the code bands 1404.

In one embodiment, the body 1402 is made of a relatively soft, flexible material such as silicone. In one embodiment, the body 1402 including the support cylinder 1415 and the cover 1406 may be formed in a molding operation. The coding bands 1403 may be independently formed and inserted into the space between the support cylinder 1415 and the cover 1406. In some embodiments, the movable bands 1403 may be formed of a harder, rigid plastic material to facilitate the rotation of the bands 1403 over the support cylinder 1415. In some embodiments, the support cylinder 1415 and cover 1406 may also be made of a harder, rigid plastic provided that the interior diameter of the support cylinder 1415 is large enough to receive the connectors 306. The bands 1403 maybe rotated by the installer to reveal the coding symbols 1404 via apertures 1407 that, in combination, identify the port to which that jumper cable 300 is to be connected. A locking mechanism may be provided to fox the bands 1403 in position such as a tang and detent arrangement, catch, ratchet or the like.

As described above, the code symbols 1104 may include any visual and/or tactile indicator or combinations of such indicators, In one preferred embodiment, the indicator is a color where each port on the RRUs and antenna 100 may be identified by a known combination of three or four colors as will hereinafter be described. In the illustrated embodiment, the coding symbols 1404 are formed of one of eight colors—red, green, blue, yellow, white, brown, purple, and orange. The cover 1406 may be formed of a contrasting color such as black to enhance visibility of the coding symbols 1404. Moreover, each coding symbol 1404 may use more than one color. While using color as the indicator is shown, other devices may be used as the coding symbols such as patterns, shapes, raised tactile areas, words, letters or the like or combinations of such devices.

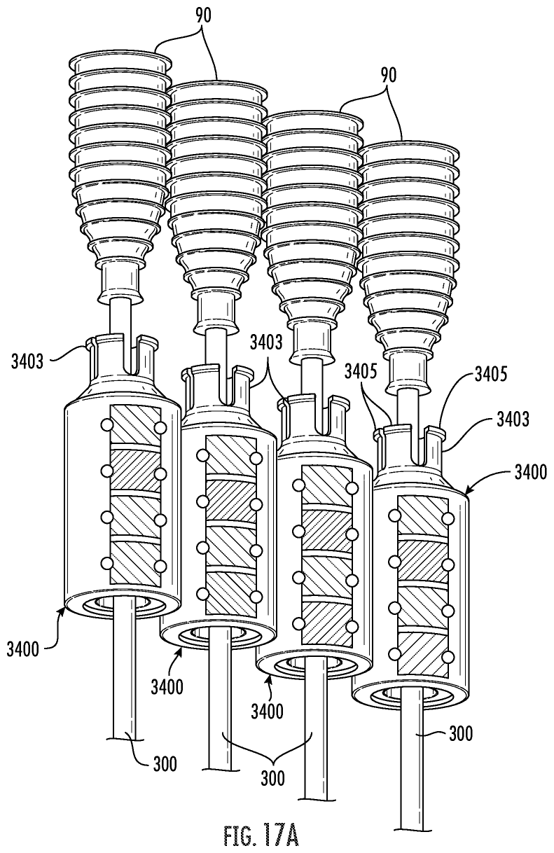

Referring to FIG. 17, another embodiment of a coding apparatus 2400 for a jumper cable 300 is shown. Coding apparatus 2400, according to embodiments of the invention, is provided at each end of the jumper cable 300 such that the code is available to the technician at the antenna 100 and at the remote radio units 200. The coding apparatus 2400 comprises the coding portion 1411 as described above without the guard boot of the embodiment of FIGS. 9 16. The coding apparatus 2400 may include a cable grip 2403 at the outer end thereof that grips the cable 302 to hold the coding apparatus 2400 in position on the cable. The cable grip may include a grommet or other similar flexibly resilient member that grips the cable 302 but is able to deform to slide over the connectors 304 at the ends of the jumper cable 300. FIG. 17A shows another embodiment of a coding apparatus 3400 for a jumper cable 300. Coding apparatus 3400, according to embodiments of the invention, is provided at each end of the jumper cable 300 such that the code is available to the technician at the antenna 100 and at the remote radio units 200. The coding apparatus 3400 comprises the coding portion 1411 similar to that described above with respect to the embodiment of FIGS. 9-16 where the guard boot 90 is provided as a separate component from the coding apparatus 3400. The coding apparatus 3400 may include a boot grip 3403 at the outer end thereof that grips the guard boot 90 to hold the coding apparatus 2400 in position relative to the guard boot 90. The boot grip 3403 may comprise a plurality of flexible fingers 3405 that resiliently deform to grip a mating structure on the guard boot 90. Other structures may be provided to grip the guard boot.

In yet another embodiment of a coding apparatus, the coding portion described with respect to FIGS. 2 through 8 may be formed without the guard boot functionality. In such an embodiment the coding symbols 404 may be formed on a cylindrical body 102 that is mounted on the each end of the jumper cable 300. The coding symbols 404 and covers 406 may be formed on the cylindrical body 402 as previously described. The body may include a passage for receiving the cable 302 and may be resiliently flexible such that it may be inserted onto the cable 302 over the connectors 304. In other embodiments a rigid body may be mounted on and secured to the cable using cable grips 2403 as described above with respect to FIG. 17.

In the embodiments described above, the coding apparatuses are made of resiliently flexible material or are made of resiliently flexible portions that allow the coding apparatuses to deform and be inserted onto the jumper cables 300 over the connectors 306. In other embodiments, the coding apparatuses may be made of a more rigid material and may have a clam shell structure such that the coding apparatuses may be opened by pivoting the clam shell halves about a hinge, such as a living hinge, and closed on the juniper cable 302 to hold the coding apparatus on the cable 302. A suitable lock such as a snap, deformable tang, friction fit or the like may be used to hold the coding apparatuses in the closed position. Other mechanisms for securing the coding apparatuses to the jumper cables 300 may be used such as straps, zip ties, adhesive, welding, clamps, heat shrink wrap or the like.

Operation of the coding systems and apparatuses will now be described. Referring to FIGS. 1C and 18-20, a code system is shown that uses three identifier variables (Sector, Frequency Band and Port Number) with the calibration ports being identified using a fourth identifier variable. The coding system shown herein is usable with antennas and radios having up to 24 RF ports and two calibration ports. The coding system uses color as the coding symbol where eight colors are used, in combination, to uniquely identify the 24 ports. For antennas and radios with fewer ports, fewer colors may be used. For antennas and radios with a greater number of ports additional colors may need to be added.

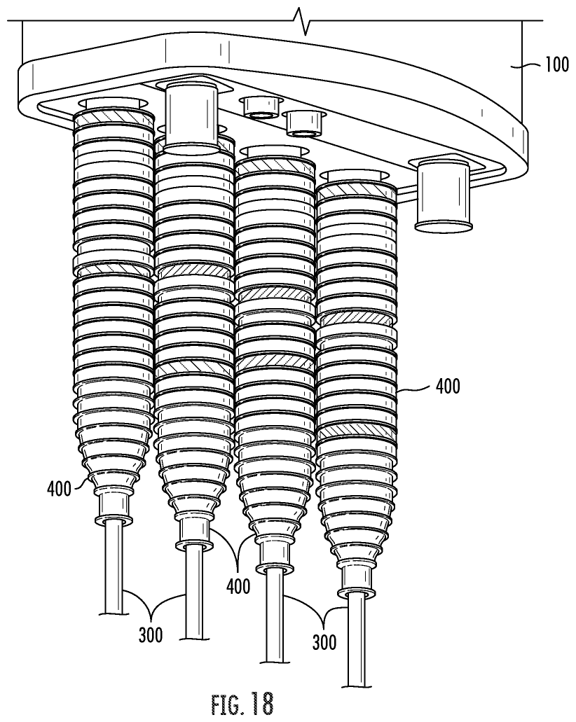

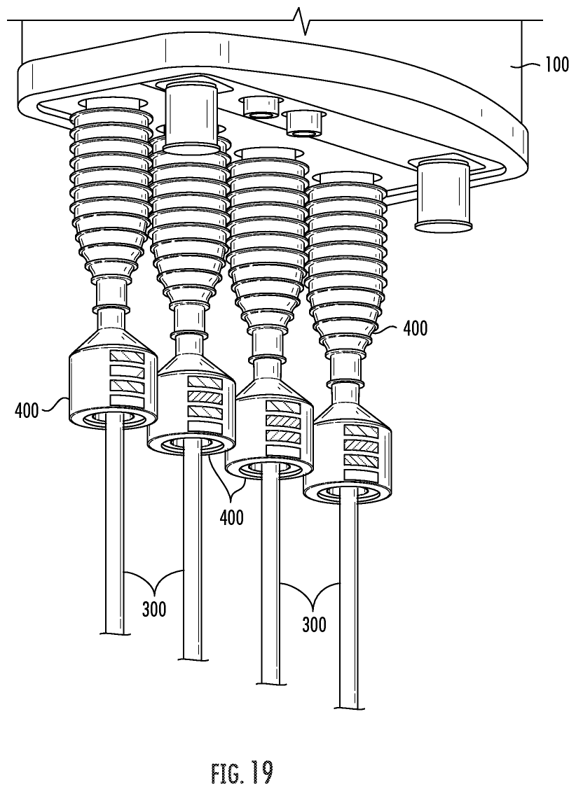

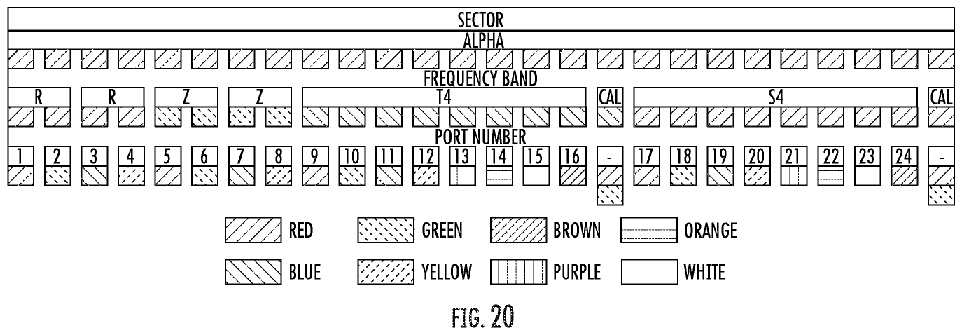

The first identifier variable is the “Sector” and is identified in the illustrated embodiment as the “Alpha” Sector (FIG. 20). The Sector variable may be used to identify the antenna 100 and RRUs 200 that are being connected. In the illustrated embodiment, the Sector may be one of three Sectors (e.g., Alpha, Beta, Gamma) identified by either Red, Green and Blue coding symbols 404 as shown in the first section 410 of FIG. 8. It is possible to identify more than three Sectors by using combinations of the colors in the first section 410. For example, both Red and Green may be used to identify a fourth Sector. In the embodiment of FIGS. 9-15, the first code band 1403a includes the three coding symbols (colors Red, Green and Blue) spaced about the periphery of the first code band 1403a and these three colors may be used to identify one of three Sectors. The technician determines, for each jumper cable 300, the Sector and reveals the color coding symbol corresponding to that Sector on the first position of the coding apparatus at each end of the jumper cable. In the embodiment of FIGS. 2-8, the cover 406 is removed from the Red coding symbol to reveal the red coding symbol. This arrangement is shown in FIG. 18 where all of the cables 300 are connected to the same antenna 100 and all the coding devices 400 show Red as the first coding symbol. In the embodiment of FIGS. 9-16 the first code band 1403a is rotated to reveal the red color on the first code band 1403a through the first aperture 1407 aligned with that band. This arrangement is shown in FIG. 19 where all of the cables 300 are connected to the same antenna 100 and all the coding devices 1400 show Red as the first coding symbol. If the Beta or Gamma Sectors were to be connected, the color coding symbols 404, 1404 corresponding to those Sectors (e.g. Green or Blue) would be revealed. The same colors are revealed on the opposite end of cables 300 that are connected to the RRUs 200.

In some embodiments, the Sector may not have to be identified because the RRUs 200 and associated antenna 100 are in close proximity to one another such that the technician can easily recognize the antenna and the RRUs that are to be connected. However, in other embodiments, such as small cell and roof top applications, the antennas and RRUs may be spaced from one another such that it may be important to identify the Sector.

The second identifier variable is the “Frequency Band” where the Frequency Band refers to the different Frequency Bands supported by the antenna 100 and RRU 200. In the illustrated embodiment, six Frequency Bands are identified as “R”, “R”, “Z”, “Z”, “T4”, and “S4”. In addition to the six Frequency Bands two calibration ports are listed, one calibration port associated with the “T4” ports and the other calibration port associated with the “S4” ports. The six Technologies may each be identified by one of six coding symbols Red, Green, Blue, Yellow, White and Brown as shown in the second section 412 of FIG. 8. In the embodiment of FIGS. 9-15. the second coding band 1403b includes the six colors Red, Green, Blue, Yellow, White and Brown spaced about the periphery of the second coding band 1403b. The technician determines, for each jumper cable 300, the Frequency Band for each jumper cable and reveals the color coding symbols 404 corresponding to that Frequency Band on the coding apparatus at each end of the jumper cable. In the embodiment of FIGS. 2-8, the cover 406 is removed from the Red coding ring for the “R” Frequency Band, the cover 406 is removed from the Green coding ring for the “Z” Frequency Band, the cover 406 is removed from the Blue coding ring for the “T4” Frequency Band and its associated calibration port, the cover 406 is removed from the Brown coding ring for the “S4” Frequency Band and its associated calibration port. This arrangement is shown in FIG. 18 where all of the cables 300 are in the same Frequency Band “S4” such that all the coding devices 400 show Brown as the second coding symbol. In the embodiment of FIGS. 9-15, the second coding ring 1403b is rotated to reveal the appropriate color coding symbol on the second coding ring 1403b via the window 1407 aligned with that band. This arrangement is shown in FIG. 19 where all of the cables 300 are in the same Frequency Band “S4” such that all the coding devices 1400 show Brown as the second coding symbol. If other Frequency Bands were used, the colors corresponding to those Frequency Bands would be revealed.

The third identifier variable is the “Port Number” where the Port Number refers to the specific ports on the antenna. In the illustrated embodiment twenty-four RF ports are identified as Port Numbers 1-24 plus the two calibration ports CAL 1 and CAL 2. Because the largest Frequency Bands (T4 and S4) have eight ports each, eight colors may be used to identify the ports. The ports may each be identified by one of eight color coding symbols Red, Green, Blue, Yellow, Purple, Orange, White and Brown shown in the third section 414 of FIG. 8. In the embodiment of FIGS. 9-15, the third coding band 1403c includes the eight colors Red, Green, Blue, Yellow, Purple, Orange, White and Brown spaced about the periphery of the second coding band 1403c. The technician determines, for each jumper cable 300, the Port Number for that jumper cable and reveals the color corresponding to that Port Number on the coding apparatus at each end of the jumper cable. In the embodiment of FIGS. 2-8 the cover 406 is removed from the Red coding ring for the first port of each Frequency Band, the cover 406 is removed from the Green coding ring for the second port of each Frequency Band, the cover 406 is removed from the Blue coding ring for the third port of each Frequency Band, the cover 406 is removed from the Yellow coding ring for the fourth port of each Frequency Band, the cover 406 is removed from the Purple coding ring for the fifth port of each Frequency Band, the cover 406 is removed from the Orange coding ring for the sixth port of each Frequency Band, the cover 406 is removed from the White coding ring for the seventh port of each Frequency Band, and the cover 406 is removed from the Brown coding ring for the eighth port of each Frequency Band. This arrangement is shown in FIG. 18 where the third coding symbols of coding devices 400 are Red, Orange Yellow and White and the cables 300 are connected to Port Nos. 1, 6, 4 and 7. In the embodiment of FIGS. 9-15, the third coding band 1403c is rotated to reveal the appropriate color coding symbol on the third coding band 1403c via the window 1407 aligned with that band, This arrangement is shown in FIG. 18 where the third coding symbols of coding devices 1400 are Red, Orange Yellow and White and the cables 300 are connected to Port Nos. 1, 6, 4 and 7.

For the calibration ports CAL 1 and CAL 2, two colors are used to identify each calibration port. The calibration ports are identified by Red and Green. To identify the calibration ports in the embodiment of FIGS. 2-8, the cover 406 is removed from both the Red and Green coding rings in the third section 414. To identify the calibration ports in the embodiment of FIGS. 9-15, the third coding band 1403c is rotated to reveal the Red color via the window 1407 associated with that band and the fourth coding band 1403d is rotated to reveal the Green color via the window 1407 associated with that band.

This process is repeated for each jumper cable. Thus, looking at the first column of the code set forth in FIG. 17, for the antenna 100 and corresponding RRU 200 identified as Sector 1, the first port (Port No. 1) is identified by the code RED-RED-RED. The second port (Port No. 2) on the same antenna and RRU is identified by the code RED-RED-GREEN. The third port (Port No. 3) on the same antenna and RRU is identified by the code RED-RED-BLUE. Each of the remaining ports may be identified by the colors in the vertical column associated with that Port Number.

The technician color codes each jumper cable prior to installation according to a “plumbing diagram” associated with the specific installation. It is to be understood that the code corresponding to the ports may differ between equipment manufacturers, service providers or the like and the specific codes shown in FIG. 20 are for explanatory purposes only. Once the jumper cables 300 are properly color coded (or otherwise coded), the technician connects the ports, typically in Port Number order, to the jumper cable coded for that port. The technician uses the plumbing diagram to identify which code corresponds to each port. It is to be understood that the term technician is used herein to refer to any individual involved in the installation process and that the person coding the jumper cables may be different than the person that physically installs the jumper cables.

Typically, the jumper cables 300 and coding apparatuses 400, 1400, 2400, 3400 are delivered to the work site with the coding apparatuses preinstalled on the jumper cables with one coding apparatus on each end of each jumper cable. It should be noted that the coding apparatuses may be different on each end of the same cable, although the codes displayed by the different coding apparatuses will be the same. Alternatively, the coding apparatuses 400, 1400, 2400, 3400 and jumper cables 300 may be delivered to the work site separately and the coding apparatuses 400, 1400, 2400, 3400 may be mounted on the jumper cables 300 at the work site by the technician; however, it may be preferable to preinstall the coding apparatuses 400, 1400, 2400 on the jumper cables by the manufacturer. The codes on the coding apparatuses may be set by a technician on the ground to identify each cable. The coding apparatuses greatly facilitate the ease and speed of coding the jumper cables as compared to existing systems that use colored electrical tape. The coded jumper cables may then be brought to the installation location such as a cell tower, roof top or the like and quickly and easily installed.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A coding apparatus configured to be mounted on a jumper cable, comprising:
a plurality of coding symbols;
a selection mechanism operable to reveal a subset of the plurality of coding symbols, the selected subset of the plurality of coding symbols, in combination, providing a code identifying a connection location for the jumper cable.

2. A coding apparatus configured to be mounted on a jumper cable, comprising:
a plurality of coding symbols;
a plurality of covers covering the respective plurality of coding symbols, the plurality of covers being movable to reveal a selected subset of the plurality of coding symbols, the selected subset of the plurality of coding symbols, in combination, providing a code identifying a connection location of the jumper cable.

3. The coding apparatus according to claim 1 comprising a body supporting the plurality of coding symbols, wherein the plurality of coding symbols are formed as bands that extend around the body, and wherein the body comprises a passage that receives the jumper cable.

4. (canceled)

5. The coding apparatus according to claim 1 wherein the plurality of coding symbols are arranged in a plurality of groups wherein each of the plurality of groups corresponds to an identifier variable, wherein the identifier variable comprises at least one of a sector variable, a frequency band variable and a port number and wherein each of the plurality of groups comprises at least two different ones of the plurality of coding symbols.

6-9. (canceled)

10. The coding apparatus according to claim 2 wherein the plurality of covers are removable from the body.

11. (canceled)

12. The coding apparatus according to claim 2 wherein each of the plurality of covers comprises a symbol identifier that identifies the coding symbol covered by each of the plurality of covers, wherein the symbol identifier comprises at least one of a letter, word, and color.

13. (canceled)

14. The coding apparatus according to claim 2 wherein each of the plurality of covers does not completely cover the coding symbol covered by each of the plurality of covers.

15. The coding apparatus according to claim 1 wherein the plurality of coding symbols comprise a plurality of different colors.

16. The coding apparatus according to claim 1 wherein the plurality of coding symbols comprise eight different colors.

17. The coding apparatus according to claim 1 wherein the plurality of coding symbols comprise at least one of a color, a pattern, a shape, a raised tactile area, a word, and a letter.

18. (canceled)

19. The coding apparatus according to claim 3 wherein the body comprises a clam shell.

20. (canceled)

21. A coding apparatus configured to be mounted on a jumper cable, comprising:
a plurality of coding symbols;
a cover covering the plurality of coding symbols, the plurality of coding symbols being movable relative to the cover to reveal a selected subset of the plurality of coding symbols, the selected subset of the plurality of coding symbols, in combination, providing a code identifying a connection location of the jumper cable.

22. The coding apparatus according to claim 21 further comprising a body, and wherein the plurality of coding symbols are rotatably mounted on the body.

23. The coding apparatus according to claim 21 further comprising a body, and wherein a plurality of bands are rotatably mounted on the body, each of the plurality of bands comprising at least one coding symbol of the plurality of coding symbols.

24. The coding apparatus according to claim 23 wherein the cover is stationary, and wherein the cover comprises a plurality of apertures where one of the plurality of apertures is aligned with each one of the plurality of bands such that the bands are rotatable whereby the selected subset of the plurality of coding symbols are visible through the plurality of apertures.

25-26. (canceled)

27. The coding apparatus according to claim 21 wherein the plurality of coding symbols are arranged in a plurality of groups, wherein each of the plurality of groups corresponds to an identifier variable, wherein one group of the plurality of groups is disposed on each of the plurality of bands, and wherein the identifier variable comprises at least one of a sector variable, a frequency band variable and a port number.

28-29. (canceled)

30. The coding apparatus according to claim 21 wherein the plurality of coding symbols comprise a plurality of different colors,

31. The coding apparatus according to claim 21 wherein the plurality of coding symbols comprise eight different colors.

32. The coding apparatus according to claim 21 wherein the plurality of coding symbols comprise at least one of a color, a pattern, a shape, a raised tactile area, a word, and a letter.

33. The coding apparatus according to claim 22 wherein the body comprises a passage that receives the jumper cable.

34-36. (canceled)
